(19) United States
(12) Patent Application Publication
(10) Pub. No.: US 2010/0281478 A1
(43) Pub. Date: Nov. 4, 2010

(54) MULTIPHASE VIRTUAL MACHINE HOST CAPACITY PLANNING

(75) Inventors: Larry Jay Sauls, Woodnville, WA (US); Sanjay Gautam, Issaquah, WA (US); Ehud Wieder, Sunnyvale, CA (US); Rina Panigrahy, Sunnyvale, CA (US); Kunal Talwar, San Francisco, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/433,919

(22) Filed: May 1, 2009

(51) Int. Cl. G06F 9/455

(52) U.S. Cl. 718/1

(57) ABSTRACT

A virtual machine distribution system is described herein that uses a multiphase approach that provides a fast layout of virtual machines on physical computers followed by at least one verification phase that verifies that the layout is correct. During the fast layout phase, the system uses a dimension-aware vector bin-packing algorithm to determine an initial fit of virtual machines to physical hardware based on rescaled resource utilizations calculated against hardware models. During the verification phase, the system uses a virtualization model to check the recommended fit of virtual machine guests to physical hosts created during the fast layout phase to ensure that the distribution will not over-utilize any host given the overhead associated with virtualization. The system modifies the layout to eliminate any identified overutilization. Thus, the virtual machine distribution system provides the advantages of a fast, automated layout planning process with the robustness of slower, exhaustive processes.

### BACKGROUND

In computer science, a virtual machine is a software implementation of a machine (computer) that executes programs like real physical hardware. System virtual machines (sometimes called hardware virtual machines) allow the sharing of the underlying physical machine resources between different virtual machines, each running its own operating system. The software layer providing the virtualization is called a virtual machine monitor or hypervisor. A hypervisor can run on bare hardware (Type 1 or native virtual machine) or on top of an operating system (Type 2 or hosted virtual machine). Some advantages of system virtual machines are: multiple operating system environments can co-exist on the same computer, in strong isolation from each other, the virtual machine can provide an instruction set architecture that is somewhat different from that of the real machine, and servers that are underutilized can be consolidated by running multiple virtual machines on one physical computer system. Multiple virtual machines each running their own operating system (called a guest operating system) are frequently used in server consolidation, where different services that used to run on individual machines in order to avoid interference are instead run in separate virtual machines on the same physical machine.

The desire to run multiple operating systems was the original motivation for virtual machines, as it allowed time-sharing a single computer between several single-tasking operating systems. This technique includes a process to share the CPU resources between guest operating systems and memory virtualization to share the memory on the host. The guest operating systems do not have to all be the same, making it possible to run different operating systems on the same computer (e.g., Microsoft Windows and Linux, or older versions of an operating system in order to support software that has not yet been ported to the latest operating system version). The use of virtual machines to support different guest operating systems is also becoming popular in embedded systems. A typical use is to support a real-time operating system at the same time as a high-level operating system such as Linux or Windows. Another use of virtual machines is to sandbox an operating system that is not trusted, possibly because it is a system under development or is exposed to viruses. Virtual machines have other advantages for operating system development, including improved debugging access and faster reboots.

Customers often want to convert physical computers in a datacenter to virtual machines for the purposes of reducing the number of physical computers they have to buy and maintain. Reducing the number of physical computers can significantly reduce operating costs. To plan for such a migration from physical computers to virtual machines, customers estimate how many physical computers they will purchase to host the new virtual machines, and they plan how to distribute virtual computers across the new physical hosts.

When performed manually, virtual machine layout is a time-consuming process that often involves extensive modeling and testing of various system loads on test hardware running the virtual machines. Failure to provide a good estimate of a virtual machine's resource consumption can lead to overburdening a physical server with too many virtual machines, resulting in poor performance, lost customer access to services running on the virtual machines, and so forth. However, a poor estimate can also lead to underutilizing hardware, resulting in excessive hardware purchases and adding to datacenter cost. Accurate planning helps a customer to increase the benefits of using virtual machines without risking poor quality of service.

Previous capacity planning tools provide some ability to automatically plan and provide a layout of deployment of virtual machines on physical computers. These systems may use estimates of how well a particular virtual machine image ran before as a standalone physical server. For example, if the image previously used 20% of the CPU, then such a system may estimate that five similar virtual machines could share the same physical hardware before consuming all of the CPU resources. These types of systems often fail to account properly for virtualization overhead (sharing the physical hardware consumes resources for managing the abstraction provided by the virtual machine). On the other hand, more extensive modeling algorithms (e.g., brute force approaches that attempt every possible combination of virtual machine and physical host) increase the time devoted to planning and often do not provide results fast enough for administrators to find them useful.

### SUMMARY

A virtual machine distribution system is described herein that uses a multiphase approach to capacity planning that provides a fast layout of virtual machines on physical computers followed by at least one verification phase that verifies that the layout is correct. The system increases the speed of determining an acceptable distribution of virtual machines onto physical hardware compared to manual processes while avoiding errors due to overutilization of physical hardware caused by naive automated processes. During the fast layout phase, the system uses a dimension-aware vector bin-packing algorithm to determine an initial fit of virtual machines to physical hardware based on rescaled resource utilizations calculated against hardware models. During the verification phase, the system uses a virtualization model to check the recommended fit of virtual machine guests to physical hosts created during the fast layout phase to ensure that the distribution will not over-utilize any host given the overhead associated with virtualization. The system will modify the layout to reassign guest virtual machines to physical hosts to eliminate any identified overutilization. Thus, the virtual machine distribution system provides the advantages of a fast, automated layout planning process with the robustness of slower, exhaustive processes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the virtual machine distribution system, in one embodiment.

FIG. 2 is a flow diagram that illustrates the multiphase approach of the virtual machine distribution system to assign virtual machines to physical hosts, in one embodiment.

FIG. 3 is a flow diagram that illustrates the processing of the fast layout component to perform an initial mapping of virtual machines to physical hosts, in one embodiment.

FIG. 4 is a flow diagram that illustrates the processing of the layout verification component to verify the initial mapping of virtual machines to physical hosts, in one embodiment.

### DETAILED DESCRIPTION

A virtual machine distribution system is described herein that uses a multiphase approach to capacity planning that provides a fast layout of virtual machines on physical computers followed by at least one verification phase that verifies that the layout is correct. The system increases the speed of determining an acceptable distribution of virtual machines onto physical hardware compared to manual processes while avoiding errors due to overutilization of physical hardware caused by naive automated processes. Each virtual machine guest is associated with a set of parameters calculated by the virtual machine distribution system that measure the virtual machine's utilization of a large number of resources (e.g., CPU, memory, I/O requests, and so forth). The system performs distribution of virtual machine guests across physical hosts in such a way that the resources available to the physical host can satisfy the resource requests of all virtual machine guests assigned to the physical host. One goal is to identify an assignment that uses a minimal number of hosts without over-utilizing any particular host.

During the fast layout phase, the system uses a dimension-aware vector bin-packing algorithm to determine an initial fit of virtual machines to physical hardware based on rescaled resource utilizations calculated against hardware models (e.g., the Microsoft System Center Capacity Planner (SCCP) hardware library models). For example, the system may determine a weighted score that indicates the resources that a virtual machine will consume, and a score that indicates the available resources of a particular physical machine. During the verification phase, the system uses a virtualization model to check the recommended fit of virtual machine guests to physical hosts created during the fast layout phase to ensure that the distribution will not over-utilize any host given the overhead associated with virtualization. For example, the system may determine that virtualization overhead will cause the suggested distribution of virtual machines to a physical server to be too high. The system will modify the layout to reassign guest virtual machines to physical hosts to eliminate any identified overutilization. Thus, the virtual machine distribution system provides the advantages of a fast, automated layout planning process with the robustness of slower, exhaustive processes.

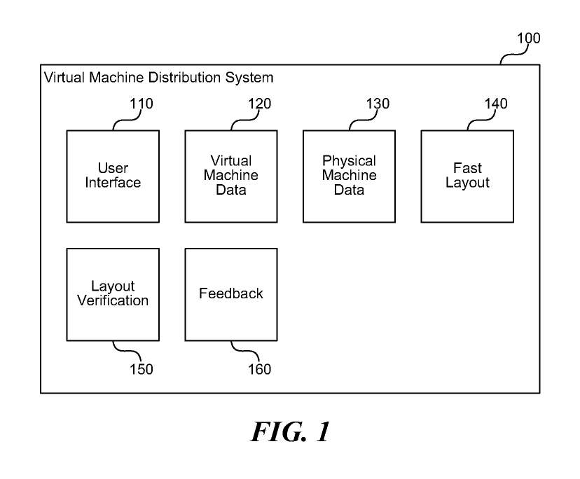

FIG. 1 is a block diagram that illustrates components of the virtual machine distribution system, in one embodiment. The system 100 includes a user interface component 110, a virtual machine data component 120, a physical machine data component 130, a fast layout component 140, a layout verification component 150, and a feedback component 160. Each of these components is described in further detail herein.

The user interface component 110 receives information about available physical resources to which to assign virtual machines, receives a set of virtual machines to assign to the physical resources, and displays results of planning to an administrator. The user interface component 110 may include a stand-alone capacity-planning tool, a web page provided by a web service, and other common user interface paradigms. Through the user interface component 110, the administrator provides information about the environment in which the administrator is planning to deploy the set of virtual machines and receives information about how to distribute the virtual machines to the available physical resources. The displayed results may include an on-screen report or data stored for later consumption (e.g., a report in a file or emailed to the administrator).

The virtual machine data component 120 identifies information about the received set of virtual machines that describes an expected load of each virtual machine. For example, the system may receive information about the expected CPU usage, memory consumption, I/O request rate, disk usage, and so forth of the virtual machine. In cases where the virtual machine is derived from a previous physical image running on physical hardware, the system may receive measured steady state and peak values that quantify the resource utilization history of the image. If the virtual machine has previously been in production use for some period, the system may receive similar measured information about the virtual machines usage parameters.

The physical machine data component 130 identifies information about the available physical resources for hosting the virtual machines. For example, the system or administrator may provide a template that specifies the available resources (e.g., size of memory, speed and cores of CPU, disk space, and so forth) of one or more typical hardware configurations (e.g., a particular server manufacturer and model number). In cases where the administrator is performing planning for a data center that will contain a uniform server type, the system may receive a template for a representative server and a count of servers that the user plans to deploy. Alternatively or additionally, the system may receive the template and provide as output of the planning process a number of servers that will ably host the specified set of virtual machines.

The fast layout component 140 receives the identified information about the available physical resources and the expected load of each virtual machine and provides an initial mapping of virtual machines to physical resources. The fast layout component 140 can use a variety of algorithms for obtaining the initial mapping. In some embodiments, the component 140 uses a dimension-aware vector bin-packing algorithm to come up with an initial mapping, described further herein. Alternatively or additionally, the fast layout component 140 may use a greedy algorithm that determines a load score for each virtual machine, sorts the virtual machines by score, and assigns the highest load virtual machine to a host first. One goal of the fast layout component 140 is to produce a good initial layout in a short amount of time. The fast layout component 140 may include tunable parameters that the system or an administrator can adjust over time to increase the accuracy of the component 140 in assigning virtual machines to physical resources.

The layout verification component 150 receives the initial mapping of virtual machines to physical resources and uses a virtualization model to ensure that the initial mapping will not lead to overutilization of any physical resource based on overhead associated with virtualization. The fast layout component 140 is good at comparing physical resource characteristics to virtual machine requests to determine the initial fit. However, virtual machines incur a certain amount of management overhead on the host physical machine that can vary based on both how the virtual machine is used and the number of virtual machines operating on the host physical machine at the same time. The layout verification component 150 incorporates information that models virtualization to ensure that virtualization overhead does not cause the initial mapping to over-utilize a physical resource.

The feedback component 160 incorporates results of layout verification into one or more tunable parameters of the fast layout component 140 to improve subsequent initial mappings of virtual machines to physical resources. For example, the layout verification component 150 may discover that due to virtualization overhead, the CPU of physical hosts is consistently over-utilized. Using this information, the layout verification component 150 may invoke the feedback component 160 to tune a CPU utilization attributed to each virtual machine so that future mappings include enough CPU space for the virtual machine in the initial mapping. Thus if the layout verification phase often rejects the assignment suggested by the fast layout phase because a particular dimension is considered over-utilized, the method used for checking whether that dimension is over-utilized can be updated to add a larger overhead. Similarly, the feedback component 160 may update a function used to sort virtual machine guests initially to incorporate domain knowledge learned from using the system 100.

The computing device on which the virtual machine distribution system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

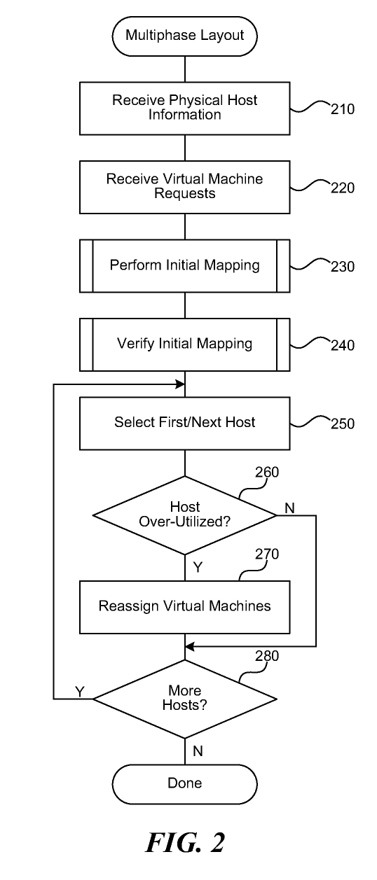

FIG. 2 is a flow diagram that illustrates the multiphase approach of the virtual machine distribution system to assign virtual machines to physical hosts, in one embodiment. Beginning in block 210, the system receives physical host capacity information that specifies the capabilities of a physical host along one or more resource dimensions. For example, the information may include a vector of host capacities (c₁, c₂, . . . , c_{d}) where each component represents a capacity of a host across a different resource dimension: CPU, memory, I/O, and so forth. Continuing in block 220, the system receives one or more virtual machine requests that specify one or more resource requirements of a virtual machine. For example, each virtual machine guest may include an associated vector of demands (g₁, g₂, . . . , g_{d}) .

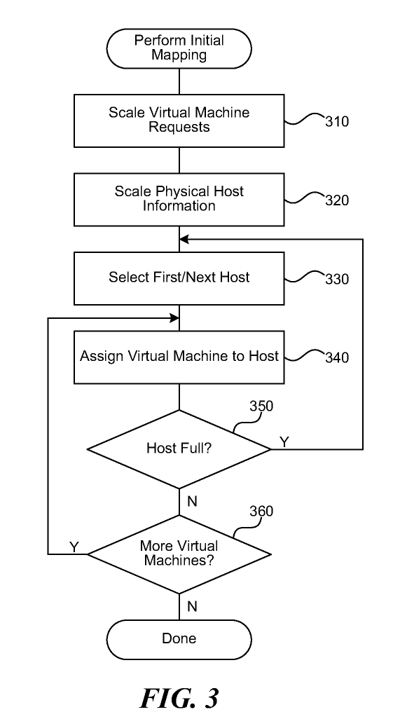

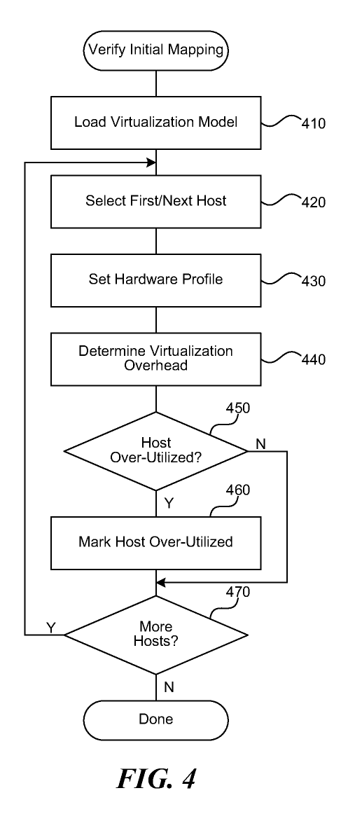

Continuing in block 230, the system performs a fast initial mapping that assigns virtual machine guests to physical hosts based on the received requests and received physical host capacity information. For example, the system may use the process described further with reference to FIG. 3. Continuing in block 240, the system verifies the initial mapping against a virtualization model to ensure that no physical host would be over-utilized if deployed based on the initial mapping. For example, the system may use the process described further with reference to FIG. 4. Continuing in block 250, the system selects a first physical host in a collection of physical hosts to which the initial mapping assigns virtual machine guests. For example, the system may traverse a list of physical hosts.

Continuing in decision block 260, if the selected host is over-utilized, then the system continues at block 270, else the system continues at block 280. Continuing in block 270, in response to determining that the selected host is over-utilized, the system reassigns at least one virtual machine from the over-utilized physical host to a less-utilized physical host. For example, the system may select a lowest utilized physical host or may re-execute the fast layout process to map one or more virtual machines assigned to the over-utilized physical host to another physical host. Following block 270, the system continues at block 280. Continuing in decision block 280, if there are more physical hosts in the collection, then the system loops to block 250 to select the next physical host, else the system completes. After block 280, these steps conclude.

FIG. 3 is a flow diagram that illustrates the processing of the fast layout component to perform an initial mapping of virtual machines to physical hosts, in one embodiment. Beginning in block 310, the component scales received virtual machine requests that specify one or more resource requirements of a virtual machine to match a hardware profile of a physical host. For example, the component may invoke a component that knows how to scale 20% CPU usage on an Intel Pentium III processor to a corresponding expected usage on physical host hardware that includes an Intel Core 2 Duo processor. The scaling ensures that the virtual machine requests are using a similar measurement unit to the available physical hosts.

Continuing in block 320, the component scales received physical host capacity information so that each of multiple resource dimensions relates to the virtual machine requests. For example, the component may scale the vector of host capacities previously described so that c₁=c₂= . . . =100. In other words, the component assumes that the demands of the virtual machine guests are given as a percentage of the physical host capacity. For example, if the CPU demand of a virtual machine guest is 20, it means hosting that guest would use 20% of the CPU capacity of the host. Continuing in block 330, the component selects a first physical host from among a set of available physical hosts to which to assign one or more virtual machine guests. For example, the component may fill the hosts one by one.

Continuing in block 340, the component assigns a virtual machine guest to the selected physical host by determining a score for each unassigned virtual machine guest that indicates a load of the virtual machine guest and comparing the score to a remaining capacity of the selected physical host. For example, the component may select the virtual machine guest with the lowest score that will fit the selected physical host. Let (c₁, c₂, . . . , c_{d}) denote the remaining capacity of a host given some current partial assignment of guests. Each variable c_i denotes the capacity of the host in dimension i minus the demand of the guests already assigned to the host. For each unassigned guest, the component calculates the score as follows:

$${\sum }_{i = 1}^{d} {w}_{i} * {( {c}_{i} - {g}_{i} )}^{2}$$

where wᵢ is a weight coefficient. The weight coefficient of dimension i is the total demand for that dimension across all remaining guests. The weight is selected so that plentiful dimensions have a small weight and scarce dimensions have a high weight. To avoid overflow, if this number is too high, it can be normalized by dividing by a fixed constant. The component assigns the guest with the lowest score that fits the host to the host, and updates the host's capacities. The component may also recalculate the score of the remaining unassigned guests after each assignment and remember the guest with the lowest score for the next assignment.

Continuing in decision block 350, if the host is full then the component loops to block 330 to select the next physical host from the set of available physical hosts, else the component continues at block 360. For example, the previous assignment of a virtual machine guest to the host may have made the host unable to accept any remaining virtual machine guests. Alternatively, the component may have failed to assign any additional virtual machine guest to the host, indicating that the host was already too full to handle additional assignments. Once the component fills a host, the component selects the next host to fill until there are no guests left to assign (or no remaining hosts if host quantity is limited). Continuing in decision block 360, if there are remaining unassigned virtual machine guests, then the component loops to block 340 to assign the next virtual machine guest, else the component completes and returns the initial mapping determined by the preceding steps. After block 360, these steps conclude.

FIG. 4 is a flow diagram that illustrates the processing of the layout verification component to verify the initial mapping of virtual machines to physical hosts, in one embodiment. Beginning in block 410, the component loads a virtualization model to check the recommended fit of virtual machine guests to hosts created in the fast layout process and ensure that no host will be over-utilized given the overhead associated with virtualization. As a result, the component will reassign guests to hosts to eliminate any overutilization found. The component reassigns by shifting guests from overloaded hosts to under-loaded hosts, if possible, and adding new hosts if no existing host can handle the reassigned guest.

Continuing in block 420, the component selects the first physical host in a collection of physical hosts to which the fast layout process assigned virtual machine guests. For example, the component may walk through the initial mapping provided by the fast layout component described herein. Continuing in block 430, the component sets parameters within the virtualization model based on the selected host and assigned virtual machine guests. In environments in which the hosts are homogenous, the system may only set host information in the model once outside the present loop. The component uses the parameters to calculate the virtualization overhead for the assignment properly.

Continuing in block 440, the component determines the virtualization overhead for the assignment of virtual machines to the selected host. The vendor of the virtualization software used to execute virtual machines may provide the virtualization model so that that model is an accurate reflection of the overhead that a host experiences due to virtualization based on internal knowledge of the virtualization software. Continuing in decision block 450, if the component determines that the selected host is over-utilized based on the current assignment of virtual machines and the anticipated virtualization overhead, then the component continues at block 460, else the component jumps to block 470. Continuing in block 460, the component flags the host as over-utilized so that the system can reassign at least one virtual machine to another host. Continuing in decision block 470, if there are more hosts in the initial mapping, then the component loops to block 420 to select the next host to which to apply the virtualization model. After block 470, these steps conclude.

In some embodiments, the virtual machine distribution system includes a time series in the fast layout calculation. For example, if the load of each guest virtual machine is available at various periods (e.g., each hour of the day), the system can create a dimension for each period. Then, the output of the initial mapping described herein would be a placement that takes into account the change of load across time. For example, the system could place two guests that are CPU intensive at different times of day on the same physical host. However, the time-complexity of the fast layout calculation increases with each dimension, so the system may select the granularity of the period considered to avoid a running time that is too large.

In some embodiments, while performing fast layout, the system first sorts the virtual machine guests in decreasing order according to the lexicographic ordering on some appropriate function of the resource consumption. The system then assigns the guests to hosts one by one according to that order. Each time, the system attempts to assign the guest to an existing host, and verifies that hosts are not over-utilized on a dimension-by-dimension basis.

In some embodiments, the input to the fast layout process also includes a method that specifies how the system checks each resource dimension. For example, the CPU utilizations of the guests placed on a host may be summed together to get an estimated CPU utilization of the host if those guests are placed on the host. The method may also add an additional overhead for the virtualization environment itself to the estimate. Finally, the method checks that the total estimated utilization does not exceed the capacity of the host. For a different dimension, such as a binary attribute denoting whether the guest requests that a keyboard be present, the method may take the logical OR of the guests' requests, and may check whether the host satisfies the relevant dimension. For other dimensions, the method may compute the highest of the values in that dimension, where the highest value is taken over the different guests that are placed on the host, and checking whether the highest value is smaller than the corresponding number for the host. If the particular assignment of guests to a particular host passes the test specified by the method in each dimension, the system considers the host not over-utilized, and permits the placement. If no existing host can accommodate the current guest, the system adds a new host to the pool of available hosts. The system proceeds in this manner until the process has assigned all guests to hosts.

The function used to sort the guests in decreasing order initially may take one of many forms. For example, one form may take the average of the rescaled resource utilization calculated in each dimension. Alternately or additionally, the function may take a weighted average, where the dimensions that are bottlenecked may get higher weight than dimensions that are underutilized on average. This weighting may be exponential, quadratic, linear, or some other function of the total utilization in that dimension. In some cases, when the dimensions have different meanings, one may sort by lexicographical order, according to the vector formed by concatenating some function of the utilizations in each dimension, with another function of the utilizations in each dimension. Thus, the first function could simply be the Boolean attribute denoting whether a keyboard is needed, and the second may be an appropriately weighted average of the other dimensions. This may be generalized to the lexicographic ordering of a vector formed by computing many different functions of the dimensions. Additionally, these functions may take as inputs random bits, or some hash function value of an identifier of the guest, to allow randomized orderings.

In some embodiments, the virtual machine distribution system may try multiple orderings of virtual machine guests to physical hosts based on the dimensions described herein. The system then picks an assignment from the orderings that provides the most acceptable utilization of the collection of physical hosts. The system may limit the number of orderings based on a threshold execution time within which the system confines the processing of the fast layout process to provide a satisfactory user experience. The system may also allow the user to configure how long the system tries additional orderings or the number of orderings tried, so that an administrator with available time can allow the system to work longer to potentially discover an improved ordering.

In some embodiments, the virtual machine distribution system operates on a collection of heterogeneous physical hosts. The tests described herein may then check against the capacity of the relevant host in each dimension. In addition, when adding new hosts (due to existing hosts being full), the system may consider the type of host to add based on how much remaining capacity will be used to host the remaining unassigned virtual machines at that point in the fast layout process described herein.

In some embodiments, the virtual machine distribution system provides an indication to an administrator of factors commonly causing physical hosts to be full. For example, the system may indicate that the physical hosts are constrained on memory and filling up before fully utilizing their processing resources. Based on this information, the administrator may choose to add cheap additional memory instead of buying expensive additional physical hosts.

From the foregoing, it will be appreciated that specific embodiments of the virtual machine distribution system have been described herein for purposes of illustration, but that various modifications may be made without deviating from the spirit and scope of the invention. Accordingly, the invention is not limited except as by the appended claims.

I/we claim:

1. A computer-implemented method for assigning virtual machines to physical hosts in multiple phases, the method comprising:
receiving physical host capacity information that specifies the capabilities of a physical host along one or more resource dimensions;
receives one or more virtual machine requests that specify one or more resource requirements of a virtual machine;
performing a fast initial mapping that assigns virtual machine guests to physical hosts based on the received requests and received physical host capacity information;
verifying the initial mapping against a virtualization model to ensure that no physical host would be over-utilized if deployed based on the initial mapping;
determining that a physical host is over-utilized based on the initial mapping and virtualization model; and
in response to determining that a physical host is over-utilized, reassigning at least one virtual machine from the over-utilized physical host to a less-utilized physical host,
wherein the preceding steps are performed by at least one processor.

2. The method of claim 1 wherein receiving physical host capacity information comprises receiving a vector of host capacities in which each component represents a capacity of a host across a different resource dimension.

3. The method of claim 1 wherein receiving one or more virtual machine requests comprises receiving a vector associated with each virtual machine that specifies demands for the virtual machine across multiple resource dimensions.

4. The method of claim 1 wherein performing a fast initial mapping comprises invoking a dimension-aware vector bin-packing process.

5. The method of claim 1 wherein verifying the initial mapping comprises determining a virtualization overhead for each host based on the initial mapping and received virtual machine requests for each virtual machine guest assigned to the host.

6. The method of claim 1 wherein determining that a physical host is over-utilized comprises determining that a load on the physical host to host each of the assigned virtual machine guests combined with a virtualization overhead would exceed at least one resource of the physical host.

7. The method of claim 1 wherein reassigning at least one virtual machine comprises selecting a lowest utilized physical host and moving the virtual machine to the lowest utilized physical host.

8. The method of claim 1 wherein reassigning at least one virtual machine comprises performing the fast mapping again with information about the virtualization overhead provided by the virtualization model.

9. A computer system for distributing virtual machines among physical hosts, the system comprising:
a processor and memory configured to execute software instructions;
a user interface component configured to receive information about available physical resources to which to assign virtual machines, receive a set of virtual machines to assign to the physical resources, and display results of planning to an administrator;
a virtual machine data component configured to identify information about the received set of virtual machines that describes an expected load of each virtual machine;
a physical machine data component configured to identify information about the available physical resources for hosting the virtual machines;
a fast layout component configured to receive the identified information about the available physical resources and the expected load of each virtual machine and provides an initial mapping of virtual machines to physical resources; and
a layout verification component configured to receive the initial mapping of virtual machines to physical resources and invoke a virtualization model to ensure that the initial mapping will not over-utilize any physical resource based on overhead associated with virtualization.

10. The system of claim 9 wherein the user interface component is further configured to receive information about the environment in which the administrator is planning to deploy the set of virtual machines and display information about how to distribute the virtual machines to the available physical resources.

11. The system of claim 9 wherein the user interface component is further configured to display a number of physical machines that will ably host the specified virtual machines based on the initial layout and verification.

12. The system of claim 9 wherein the virtual machine data component is further configured to receive measured steady state and peak values that quantify the resource utilization history of a virtual machine image.

13. The system of claim 9 wherein the physical machine data component is further configured to receive a template that specifies the available resources of one or more available hardware configurations.

14. The system of claim 9 wherein the fast layout component is further configured to invoke a dimension-aware vector bin-packing process to create the initial mapping.

15. The system of claim 9 wherein the fast layout component is further configured to invoke a greedy process that determines a load score for each virtual machine, sorts the virtual machines by score, and assigns the highest load virtual machine to a host first.

16. The system of claim 9 wherein the fast layout component is further configured to receive one or more tunable parameters that the system or an administrator can adjust to increase the accuracy of the component in assigning virtual machines to physical resources.

17. The system of claim 9 further comprising a feedback component configured to incorporate results of layout verification into one or more tunable parameters of the fast layout component to improve subsequent initial mappings of virtual machines to physical resources.

18. The system of claim 17 wherein the feedback component is further configured to modify a sorting function used to sort virtual machines prior to fast layout.

19. A computer-readable storage medium comprising instructions for controlling a computer system to perform a fast mapping of virtual machines to physical hosts, wherein the instructions, when executed, cause a processor to perform actions comprising:
scaling virtual machine requests that specify one or more resource requirements of a virtual machine to match a hardware profile of a physical host;
scaling physical host capacity information so that each of multiple resource dimensions relates to the virtual machine requests;
selecting a first physical host from among a set of available physical hosts to which to assign one or more virtual machine guests;
assigning a virtual machine guest to the selected first physical host by determining a score for each unassigned virtual machine guest that indicates a load of the virtual machine guest and comparing the score to a remaining capacity of the selected physical host; and
in response to determining that the selected first physical host is full, selecting a second physical host to which to assign subsequent virtual machine guests.

20. The medium of claim 19 wherein determining a score comprises applying a weighting to each of multiple resource dimensions, wherein the weighting determines an impact of the dimension on the score.
